(19) United States
(12) Patent Application Publication
(10) Pub. No.: US 2004/0179941 A1
(43) Pub. Date: Sep. 16, 2004

(54) Turboprop engine with co-rotating two-stage high-performance propeller

(76) Inventor: Dimitrie Negulescu, Berlin (DE)

Correspondence Address: Davidson Berquist, Klima & Jackson LLP, Suite 920, 4501 North Fairfax Drive, Arlington, VA, 22203, US

(21) Appl. No.: 10/774,684

(22) Filed: Feb. 10, 2004

(30) Foreign Application Priority Data
Feb. 10, 2003 (DE) DE 103 05 352.2

(51) Int. Cl. F03D 1/02

(52) U.S. Cl. 416/120

(57) ABSTRACT

A propeller-turbine engine includes a gas generator engine with a gearbox and a propeller hub, wherein two propellers are arranged axially offset relative to each other on the propeller hub which rotate in the same direction.

This application claims priority to German Patent Application DE10305352.2 filed Feb. 10, 2003, the entirety of which is incorporated by reference herein.

### BACKGROUND OF THE INVENTION

This invention relates to a turboprop engine, or a propeller-turbine engine

Various designs of turboprop engines (propeller-turbine engines) are known from the state of the art. In turboprop-type engines, a propeller is driven by the drive shaft of a gas generator engine via a gearbox. Thus, the shaft power of the engine is transformed into thrust. The propeller must have appropriately sized blade tip and blade hub diameters to be sufficiently efficient. Furthermore, a large number of propeller blades with an appropriately wide chord is required. A disadvantage lies in the fact that the propeller hub must be sufficiently sized to accommodate the pitch-control mechanism for the propeller blades. The size of the propeller hub is, however, confined by design constraints in terms of undesirably high weight on the one hand and complexity of the engine mounting arrangement on the other hand.

A further disadvantage of known turboprop engines lies in the fact that the pressure losses in the engine intake become very large at very high power, for example, more than 8,000 HP on one propeller stage. This entails the risk of flow instabilities in the compressor inlet.

Co-axially counter-rotating propellers are, therefore, proposed in the state of the art.

However, these propeller configurations entail heavy and complex designs of the propeller hubs. Furthermore, they produce a high noise level, which is undesirable.

### BRIEF SUMMARY OF THE INVENTION

In a broad aspect, the present invention provides a turboprop engine in accordance with the type mentioned at the beginning which shows good overall efficiency of the propulsion system while avoiding the disadvantages of the state of the art at high power.

It is a particular object of the present invention to provide solution to the above problems by the combination of the features described herein. Further advantageous embodiments of the present invention become apparent from the description below.

The present invention, therefore, provides for an arrangement of two propellers on the propeller hub, which are axially offset relative to each other and which rotate in the same direction. The propeller hub accordingly drives two propellers which, being mounted on one and the same hub, have the same speed.

It is particularly favorable if the two propellers have the same number of blades and are accordingly axially offset relative to each other on the propeller hub. In a particularly favorable embodiment of the present invention, the two propellers are circumferentially offset relative to each other to provide for aerodynamic optimization.

This improves the flow conditions at the propeller blades. It is particularly advantageous if the two propellers are provided with continuously variable and interconnected mechanisms for controlling the propeller blade pitch.

In a development of the present invention, it is favorable to provide the propeller hub with an annular boundary-layer suction inlet between both propellers to optimize the flow conditions. This secondary boundary-layer suction inlet ensures a high inlet efficiency of the downstream turboprop engine air intake. Furthermore, the boundary-layer suction inlet is a very effective particle separator for the turboprop engine air intake.

The present invention is further advantageous in that the frontal area of the axially offset co-rotating two-stage propeller and the frontal area of the required hub areas are only approximately 60 percent of the respective areas of a conventional one-stage propeller of similar performance. This not only reduces the flow resistance, it also enables a considerable weight saving to be achieved.

In accordance with the present invention, it is also advantageous that the required speed-reduction ratio of the propeller gearbox can be relatively small, compared to the state of the art. This will also result in a saving of weight and a reduction of dimensions.

The propeller design according to the present invention allows for a great variety of engine air intakes. For example, NACA air intakes can be used whose leading edges are inclined to the propeller exit swirl flow. In accordance with the present invention, it is also possible to use annular inlets or scoop inlets.

### BRIEF DESCRIPTION OF THE DRAWING

Further aspects and advantages of the present invention will become apparent in light of the accompanying drawing, showing an embodiment. On the drawing, the sole FIGURE shows a schematic side view of a turboprop engine in accordance with the present invention.

### DETAILED DESCRIPTION OF THE INVENTION

This detailed description should be read in conjunction with the summary of the invention above, which summary is incorporated by reference in this detailed description.

The FIGURE shows, in schematic representation, a nacelle 7 which is mounted to a wing 8 (only partially shown) of an aircraft. For reasons of simplicity, the representation of the gas generator engine was dispensed with. Various air intakes 6 are provided on the nacelle 7 which are designed as NACA intakes.

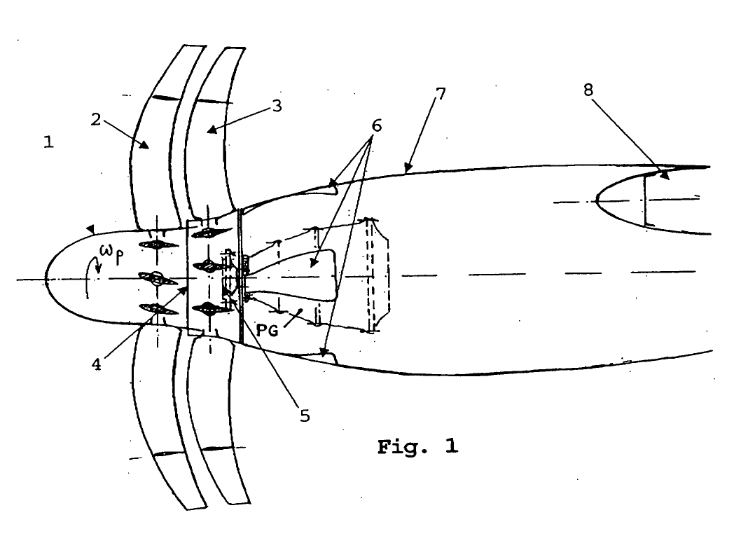

Reference numeral 5 designates a flange-type connection between a gearbox (not shown in detail) and a propeller hub 1 in simplified representation. A front propeller 2 and a rear propeller 3 are provided on the propeller hub 1 which rotate with the same circumferential speed. A boundary-layer suction inlet 4 is provided between the two propellers 2 and 3 on the propeller hub 1. As shown in FIG. 1, a rear portion of the propeller hub 1 supporting the rear propeller 3 can be somewhat larger than a front portion of the propeller hub 1 supporting the front propeller and the boundary-layer suction inlet 4 can be positioned at the transition between the two differently sized portions of the hub, so that such inlet is forward facing and is in the form of an annular or scoop inlet. Alternative inlet configurations and positioning can also be used, such as a NACA type inlet, and the two portions of the hub supporting the two different propellers can be sized and configured as desired. It is also contemplated that more than two propellers can be used in the present invention. The different portions of the propeller hub 1 supporting the different propellers can be unitary in construction or can be constructed of multiple components connected to rotate together.

In a particularly favorable embodiment of the present invention, the two propellers are circumferentially offset relative to each other to provide for aerodynamic optimization. This circumferential offset can be fixed or a mechanism can be provided that can adjust the offset, for aerodynamic optimization based on the operating characteristics. In a preferred embodiment, the amount of adjustment would be up to about the circumferential pitch between blades.

An advantage of the present invention is the weight saving mentioned in the above. A further advantage lies in the fact that the efficiency of the propulsion unit according to the present invention is enhanced by reduction of the inlet pressures loss and of the nacelle frontal area.

Furthermore, the present invention provides for the use of propeller gearboxes with a relatively small speed-reduction ratio. This enables the weight of the turboprop engine to be further reduced. A further advantage compared to known turboprop engines with co-axial and counter-rotating propellers is the reduction of noise.

What is claimed is:

1. A propeller-turbine engine arrangement comprising:
a gas generator engine;
a gearbox connected to the engine;
a propeller hub connected to the gearbox; and
two propellers arranged axially offset relative to each other on the propeller hub which rotate in the same direction.

2. An arrangement in accordance with claim 1, wherein the two propellers are a front propeller and a rear propeller and the front propeller is circumferentially offset to the rear propeller.

3. An arrangement in accordance with claim 2, wherein the front propeller and the rear propeller have the same number of blades.

4. An arrangement in accordance with claim 3, wherein the propeller blades of both propellers can be pitch-controlled.

5. An arrangement in accordance with claim 4, wherein the propeller hub includes an annular boundary-layer suction inlet positioned between both propellers.

6. An arrangement in accordance with claim 1, wherein the two propellers are a front propeller and a rear propeller, and the front propeller and the rear propeller have the same number of blades.

7. An arrangement in accordance with claim 6, wherein the propeller blades of both propellers can be pitch-controlled.

8. An arrangement in accordance with claim 7, wherein the propeller hub includes an annular boundary-layer suction inlet positioned between both propellers.

9. An arrangement in accordance with claim 1, wherein each propeller includes a plurality of blades and the blades of both propellers can be pitch-controlled.

10. An arrangement in accordance with claim 9, wherein the propeller hub includes an annular boundary-layer suction inlet positioned between both propellers.

11. An arrangement in accordance with claim 1, wherein the propeller hub includes an annular boundary-layer suction inlet positioned between both propellers.

12. An arrangement in accordance with claim 2, wherein the propeller hub includes an annular boundary-layer suction inlet positioned between both propellers.

13. An arrangement in accordance with claim 3, wherein the propeller hub includes an annular boundary-layer suction inlet positioned between both propellers.

14. An arrangement in accordance with claim 2, wherein the propeller blades of both propellers can be pitch-controlled.

15. An arrangement in accordance with claim 14, wherein the propeller hub includes an annular boundary-layer suction inlet positioned between both propellers.

16. An arrangement in accordance with claim 7, wherein the propeller hub includes an annular boundary-layer suction inlet positioned between both propellers.

17. An arrangement in accordance with claim 5, wherein the suction inlet is in the form of at least one of an annular inlet, a scoop inlet and a NACA type inlet.

18. An arrangement in accordance with claim 11, wherein the suction inlet is in the form of at least one of an annular inlet, a scoop inlet and a NACA type inlet.

19. An arrangement in accordance with claim 2, wherein the circumferential offset is variable.

20. An arrangement in accordance with claim 19, including a mechanism positioned between the front blade and the rear blade for adjusting the circumferential offset.

21. An arrangement in accordance with claim 20, wherein mechanism for adjusting the circumferential offset can adjust the circumferential offset by up to a circumferential pitch between adjacent blades.

22. A propeller arrangement for a gas generator engine, comprising;
a propeller hub connectable to the engine; and
two propellers arranged axially offset relative to each other on the propeller hub which rotate in the same direction.

23. An arrangement in accordance with claim 22, wherein the two propellers are a front propeller and a rear propeller and the front propeller is circumferentially offset to the rear propeller.

24. An arrangement in accordance with claim 23, wherein the front propeller and the rear propeller have the same number of blades.

25. An arrangement in accordance with claim 24, wherein the propeller blades of both propellers can be pitch-controlled.

26. An arrangement in accordance with claim 25, wherein the propeller hub includes an annular boundary-layer suction inlet positioned between both propellers.

27. An arrangement in accordance with claim 23, wherein the circumferential offset is variable.

28. An arrangement in accordance with claim 27, including a mechanism positioned between the front blade and the rear blade for adjusting the circumferential offset.

29. An arrangement in accordance with claim 28, wherein mechanism for adjusting the circumferential offset can adjust the circumferential offset by up to a circumferential pitch between adjacent blades.
